(19) United States
(12) Patent Application Publication
(10) Pub. No.: US 2005/0271225 A1
(43) Pub. Date: Dec. 8, 2005

(54) Audio preview apparatus for display articles

(76) Inventor: Fung-Chun Hsu, Kaohsiung County (TW)

Correspondence Address: BIRCH STEWART KOLASCH & BIRCH, PO BOX 747, FALLS CHURCH, VA, 22040-0747, US

(21) Appl. No.: 10/862,430

(22) Filed: Jun. 8, 2004

(51) Int. Cl. H04B 1/00; H04R 1/02

(52) U.S. Cl. 381/124; 381/334; 381/386

(57) ABSTRACT

An audio preview apparatus for display articles adopted for use on a display rack to display articles and provide trial hearing of buzz effect. It includes a host box which contains an audio IC or buzzer and a speaker, and a connector located outside the host box to connect to a touch button. The host box and the touch button have respectively a first magnet and a second magnet on one side attracting each other for mounting on the display rack. The audio effect of the display articles may be tested without direct handling of the consumers.

### FIELD OF THE INVENTION

The present invention relates to an audio preview apparatus for display articles that includes a host box and a touch button attached to each other and mounted onto a display rack to enable consumers to do trial hearing of audio conditions of the display articles.

### BACKGROUND OF THE INVENTION

Conventional article display racks, especially those used in large stores that house a lot of merchandises, merely are for holding and displaying articles and do not have other purposes. For displaying audio articles (alarm clocks are used as examples in this application), the new alarm clocks are generally displayed on the display racks marked with model numbers and prices without connecting to electric power. Based on appearance it is not possible to known the sound quality, volume, or sound type (such as music or buzz). Store clerks have to install batteries and do necessary settings and turn on switches to activate the clocks to enable consumers to determine whether the clocks meet their requirements and satisfactions. It is a tedious and time-consuming process. After repeatedly tests and trial hearing, tears and wears often occur to the articles, even damage could happen. It becomes a loss to the vendors and shop owners. Moreover, with consumers directly testing the display new articles other problems might occur, notably:
1. With the articles directly tested by consumers, the possibility of shoplifting and theft increases.
2. With the articles directly touched and compressed by consumers, normal operating conditions have to be constantly monitored. Otherwise product damage might occur and the audio functions could be not meeting consumers' requirements, and result in dropping of consumers' purchase desire.
3. As the goods with pre-loaded batteries will consume electric power and result in aging and wearing, the displaying goods generally are not connected to electricity. When consumers want to confirm the requirements, they have to take the goods to the clerks to hook up with electricity to test the audio quality and conditions. The test might go on for a number of different products. It takes a lot of time. Some consumers are reluctant to take so much troubles and might settle for products that do not fully meet their requirements.

### SUMMARY OF THE INVENTION

In view of the aforesaid disadvantages, the present invention aims to provide a preview apparatus that couples with a display rack and may be installed independently to overcome the shortcomings occurred to the conventional display racks so that the displaying articles may be previewed without actual operation and wearing and consumers can rapidly confirm audio requirements and make purchase decision. Therefore consumers have improved protection and may procure brand new goods not being repeatedly tested by other people, and damage of the displaying goods may be reduced. It also helps to increase consumers' purchase desire.

In short, the present invention provides the following features and functions:

1. The invention is a display preview apparatus that does not need service people to repeatedly load batteries for customers to do trial-hearing, therefore can reduce waste of manpower and unnecessary negligence of service people.

2. The apparatus according to the invention may be independently set up to mate the display rack. Display articles may be tried and tested by consumers conveniently without the pressure of sales clerks attending nearby, hence consumer's purchase desire may increase.

3. The apparatus according to the invention may be changed and replaced rapidly according to the display articles without disassembling the display rack.

4. The apparatus according to the invention allows the audio functions of the products to be fully understood without unpacking. It is adaptable to different types of display articles and enables a plurality of products to be tested for audio quality and effect to meet consumer's requirements.

5. The invention can reduce damage of the display articles caused by frequent trials and tests of consumers, and enables the consumers to confirm rapidly and directly whether the products meeting their requirements.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is an exploded view of the present invention.

FIG. 2 is a perspective view of the present invention.

FIG. 3 is a schematic view of the present invention in a first configuration.

FIG. 4 is a schematic view of the present invention in a second configuration.

FIG. 5 is a schematic view of the present invention in a third configuration.

### DETAILED DESCRIPTION OF THE PREFERRED EMBODIMENTS

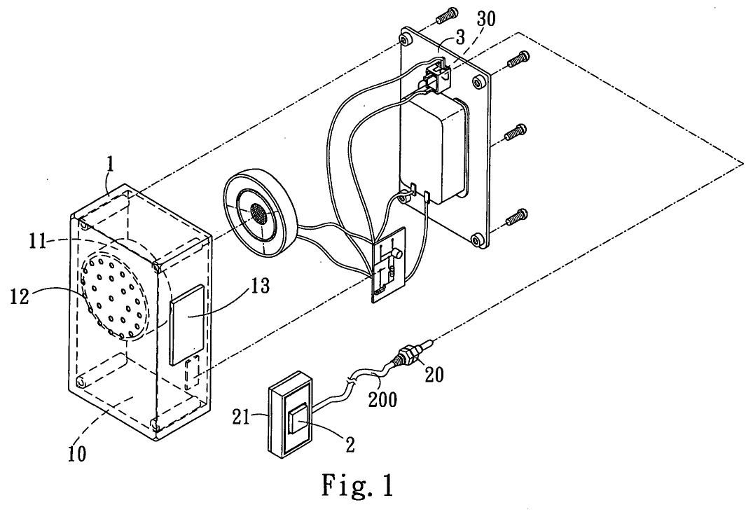

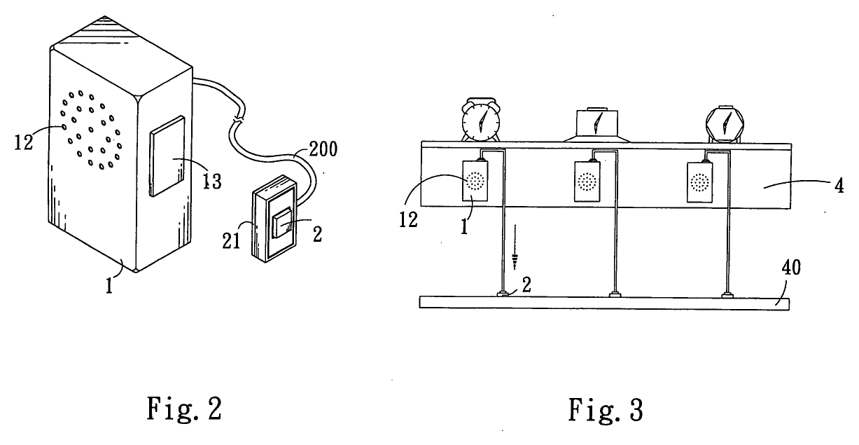

Please referring to FIGS. 1 and 2, the preview apparatus according to the invention includes a host box 1 and a touch button 2 that are connected to each other through a movable wire. The host box 1 has an IC compartment 10 (or buzzer compartment) and a speaker compartment 11 on another side that are connected to each other and linked respectively to a connector 30 mounted onto an outer side of a bottom lid 3 of the host box 1. The connector 30 is coupled with a lever 20 of the touch button 2 to control the movement of the host box 1. The host box 1 has speaker apertures 12 on one surface corresponding to the speaker compartment 11 and a first magnet 13 on another side, and is coupled with the bottom lid 3 on the bottom side. The lever 20 of the touch button 2 is connected to a power cord 200. The touch button 2 further has an inner side attached to a second magnet 21 which may be attracted to the. first magnet 13 of the host box 1.

Refer to FIG. 2 for the preview article mounting on the display rack 4. Various configurations may be adopted. FIG. 3 illustrates a first configuration. The host box 1 is located on the display rack 4 corresponding to a display article in an one-on-one manner. The touch button 2 is located on a counter 40. This approach can prevent consumers from directly in contact with the article before they fully understand the operation method so that the display article may be prevented from being damaged by improper operation. The speaker in each host box 1 is actuated by the touch button 2 to generate sound so that consumers may know the audio quality and effect to achieve the preview purpose.

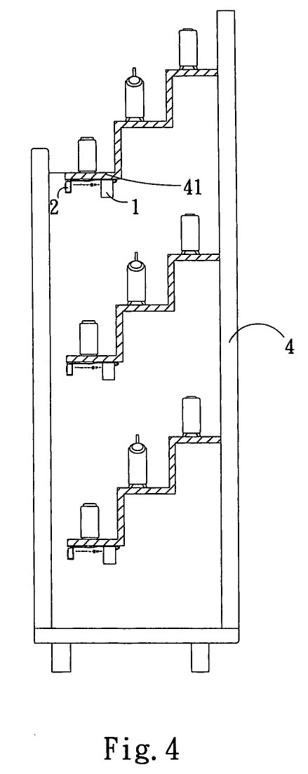

Refer to FIG. 4 for a second configuration. The host box 1 and the speaker of each host box 1 are mounted onto a bottom level 41 of the stepwise display rack 4. The first magnet 13 of the host box 1 is directed outwards to attract the second magnet 21 of the coupled touch button 2. Audio effect (buzz or music) is converged and generated from the touch button 2 through the speaker apertures 12 of the host box 1 to achieve direct trial hearing rapidly.

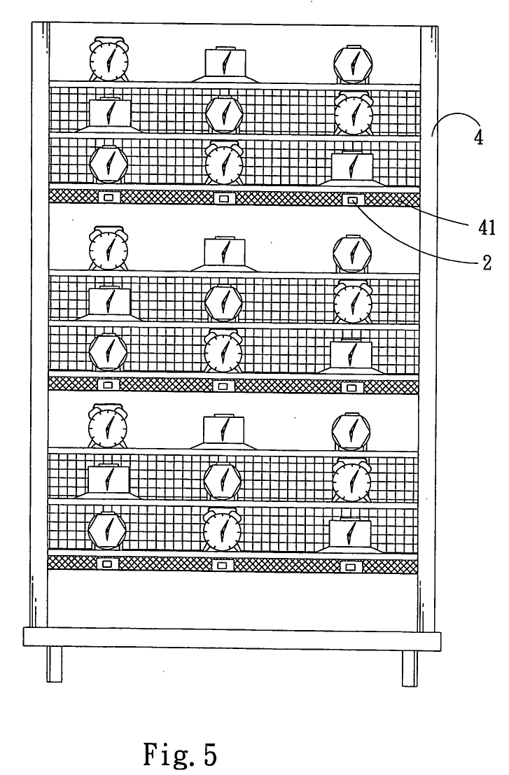

Refer to FIG. 5 for a third configuration. The host box 1 and the touch button 2 are located on a lower side of the display rack 4. This is approach is preferably for a smaller display location or space.

It is to be noted that in the event of change of the display articles is desired on the display rack, it can be accomplished by merely replacing the IC or buzzer in the IC compartment 10. The wiring remains the same without altering. Thus change can be made rapidly to achieve the desired preview effect.

1. An audio preview apparatus for display articles to independently display articles on a display rack for preview, comprising:
a host box which includes an IC compartment and a speaker compartment that are changeable and a connector located on an outer side of a bottom lid of the host box connecting to the IC compartment and the speaker compartment; and
a touch button which includes a lever connecting to the host box through a movable wire;
wherein the host box and the touch button are located on the display rack according to the type and display space of the display rack to prevent the display articles from being directly operated and to achieve preview effect.

2. The audio preview apparatus for display articles of claim 1, wherein the speaker compartment includes a speaker, the host box having speaker apertures on one surface corresponding to the speaker compartment to generate sound.

3. The audio preview apparatus for display articles of claim 1, wherein the host box and the touch button have respectively a first magnet and a second magnet located on one side attracting each other for mounting on the display rack.
